(19) United States
(12) Patent Application Publication
(10) Pub. No.: US 2008/0181446 A1
(43) Pub. Date: Jul. 31, 2008

(54) Structure of a miniaturized high power speaker

(76) Inventor: Wei Hsu, Taipei County (TW)

Correspondence Address: Wei Hsu, P.O. Box 44 - 2049, Taipei, 10668, omitted

(21) Appl. No.: 11/698,837

(22) Filed: Jan. 29, 2007

(51) Int. Cl. H04R 1/00

(52) U.S. Cl. 381/412

(57) ABSTRACT

A structure of a miniaturized high power speaker is mainly composed of a vibrator and a magnetic loop assembly. The vibrator includes a voice coil set, a diaphragm and a flange. The magnetic loop assembly includes a thin magnet set, a thick magnet set and a magnetic base. According to this structure, the miniaturized high power speaker of the invention can specifically present the loudness of voice and the extension of the low frequency band and can withstand multiple times of the input power without distortion. Also, the speaker can simplify the assembling trouble and difficulty during the mass production so that the smooth effectiveness may be kept and the excellent precision can be obtained.

### BACKGROUND OF THE INVENTION

(1) Field of the Invention

The invention relates to a structure of a speaker, and more particularly to a structure of a miniaturized high power speaker having the reproducibility, the precision consistency and the high efficiency.

(2) Description of the Prior Art

Components used in a conventional miniaturized speaker are not too different from those used in a middle-scale speaker or a large-scale speaker. The greatest difference therebetween is only the size modification. The components that are usually used have more than ten elements including a diaphragm, a corrugated rim, a waved centering piece, a voice coil frame, a copper winding, a wire frame, a magnetic block, a magnetic pole block, intertwisted copper wires, a hollow frame, a dustproof hat. The operation principle is to push the diaphragm to vibrate the air to generate the voice that can be heard by the human ears according to attractive and repellent forces generated by the electromagnetic field or the charges. In other words, the speaker is a simple energy converter for converting the electric energy into the sound energy. Although the principle and the components are very simple, the precision cannot be easily obtained in practice.

However, the types of the present personal electronic products, such as a portable computer, a mobile phone, a PDA, a language learner, are very complicated. The miniaturized speaker has become the essential part of the product. More particularly, the speaker must have the small size, the good sound quality, and the great power under the trend of the light, thin and miniaturized design and the severe requirement on the quality. Thus, the materials of the selected components and the structure designs must be properly modified in order to satisfy the varying requirements in the market. Thus, the structure, the manufacturing method and the power behavior of the present miniaturized speaker still have to be improved.

In view of this, the applicant knows that the structure design of the miniaturized speaker has to be made by considering the reproducibility, the precision consistency and the high efficiency for satisfying the rule of mass production in order to shorten the manufacturing flow and to decrease the manpower and the material cost. In addition, it is necessary to select the most suitable component materials and the precision control of the manufacturing processes, and to request the smooth and effective flow so that the required miniaturized high power speaker can be manufactured. Thus, the utility product of the miniaturized high power speaker is provided in this invention according to the experience, the professional knowledge, the time, and the efforts.

### SUMMARY OF THE INVENTION

It is therefore an object of the invention to provide a miniaturized high power speaker capable of specifically presenting the loudness of voice and the extension of the low frequency band and withstanding multiple times of input power without distortion.

Another object of the invention is to provide a miniaturized high power speaker capable of simplifying the assembling trouble and difficulty during the mass production so that the smooth effectiveness may be kept and the excellent precision can be obtained.

The invention achieves the above-identified objects by providing a miniaturized speaker composed of a vibrator and a magnetic loop assembly.

The vibrator includes: a voice coil set having a cylindrical voice coil frame, one lateral circumference formed with projecting and opposite lead-out portions, and another lateral circumference wound with a copper wire, wherein each of the lead-out portions is bonded to a conductive terminal and adhered to an inner wall of a guide-out tube with the terminal being exposed out of an edge of the guide-out tube; a diaphragm, which is composed of a large elastic film and a small light metal, and is adhered to the voice coil set; and a flange which is a circular hollow frame body made of a metal material, wherein the voice coil set may be embedded into the circular hollow frame body and adhered to the diaphragm.

The magnetic loop assembly includes a thin magnet set composed of a thin magnet and a thin washer having a central hole, wherein the thin magnet and the thin washer are pressed and adhered together and are magnetized to have a strong magnetic force; a thick magnet set composed of a thick magnet and a thick washer having a central hole, wherein the thick magnet and the thick washer are pressed and adhered together, and are magnetized to have another strong magnetic force; and a magnetic base, which is a circular outer cover having a central hole, wherein the thick magnet set and the thin magnet set are sequentially disposed in the central hole of the circular outer cover concentrically.

According to the above-mentioned speaker, the effects of the small size, the good voice quality and the great power can be achieved.

Further aspects, objects, and desirable features of the invention will be better understood from the detailed description and drawings that follow in which various embodiments of the disclosed invention are illustrated by way of examples.

### BRIEF DESCRIPTION OF THE DRAWINGS

FIG. 1 is a rough exploded view showing a speaker according to a preferred embodiment of the invention.

FIG. 2 is a first detailed exploded view showing the speaker according to the preferred embodiment of the invention.

FIG. 3 is a second detailed exploded view showing the speaker according to the preferred embodiment of the invention.

FIG. 4 is a schematically developed view showing a voice coil frame according to the preferred embodiment of the invention.

FIG. 5 is a schematic illustration showing operations of forming the voice coil frame according to the preferred embodiment of the invention.

FIG. 6 is an external and partially cross-sectional view showing a voice coil according to the preferred embodiment of the invention.

FIG. 7 is an externally assembled view showing the speaker according to the preferred embodiment of the invention.

FIG. 8 is an overall cross-sectional view showing the speaker according to the preferred embodiment of the invention.

### DETAILED DESCRIPTION OF THE PREFERRED EMBODIMENTS

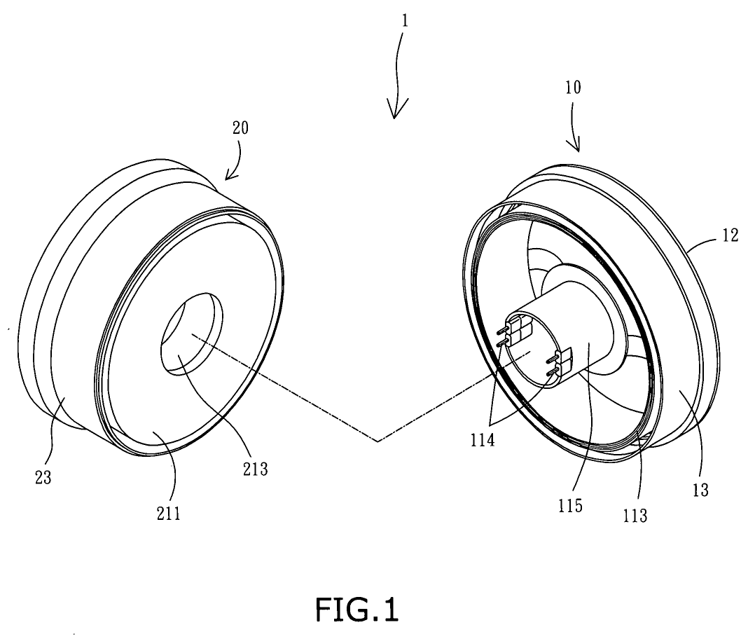

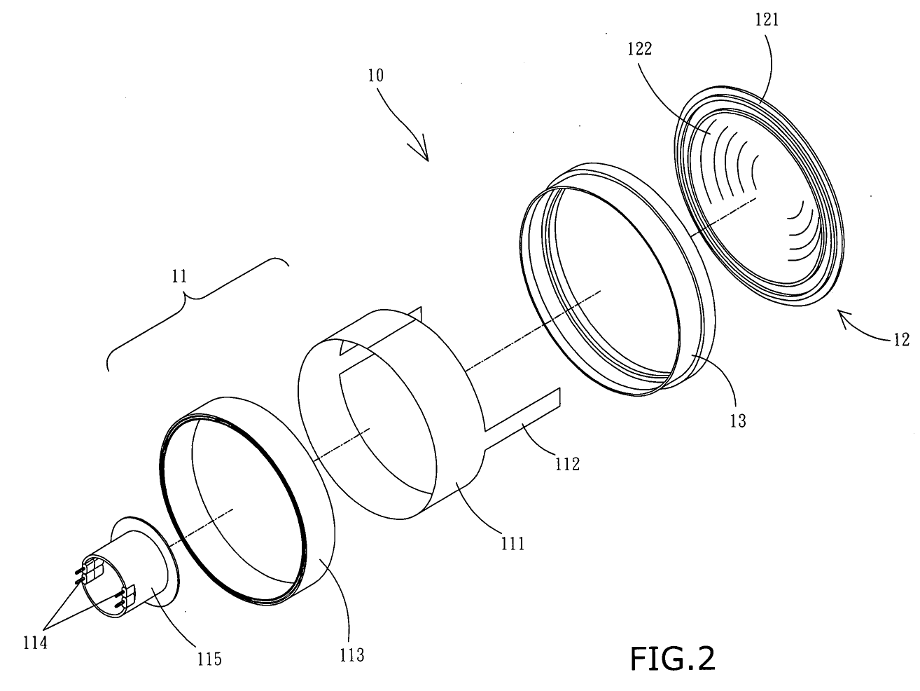

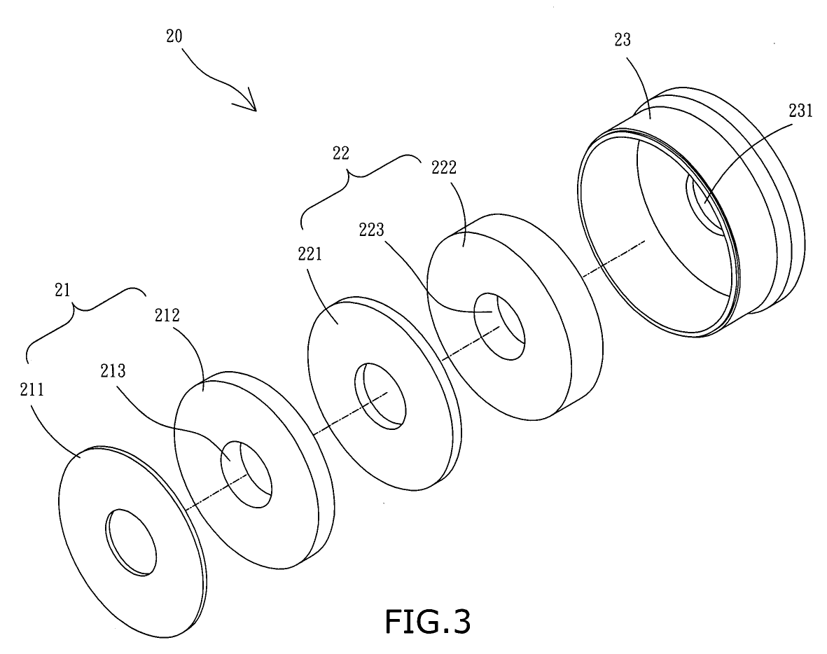

FIGS. 1 to 3 are respectively a rough exploded view and detailed exploded views showing a speaker according to a preferred embodiment of the invention. As shown in FIGS. 1 to 3, the speaker 1 is mainly composed of a vibrator 10 serving as an upper half portion, and a magnetic loop assembly 20 serving as a lower half portion.

The vibrator 10 includes a voice coil set 11, a diaphragm 12 and a flange 13.

The voice coil set 11 has a flexible and cylindrical voice coil frame 111, one lateral circumference formed with projecting and opposite lead-out portions 112, and another lateral circumference wound with a copper wire 113. The lead-out portions 112 are respectively bonded with conductive terminals 114, and are adhered to an inner wall of a guide-out tube 115 with the terminals 114 being exposed out of an edge of the guide-out tube 115.

The diaphragm 12 includes an elastic film 121 having the larger size and serving as an outer layer, and a light metal 122 having the smaller size and serving as an inner layer, and is adhered to the voice coil set 11.

The flange 13 is made of a metal material and formed into a circular hollow frame body, into which the voice coil set 11 can be embedded. The circular hollow frame body and the diaphragm 12 may be adhered together.

The magnetic loop assembly 20 includes a thin magnet set 21, a thick magnet set 22, and a magnetic base 23.

The thin magnet set 21 is composed of a thin magnet 212 and a thin washer 211 having a central hole 213, both of which are pressed and adhered together and then magnetized using a magnetizer in order to have the strong magnetic force.

The thick magnet set 22 is composed of a thick magnet 222 and a thick washer 221 having a central hole 223, both of which are pressed and adhered together, and then magnetized using the magnetizer in order to have the strong magnetic force.

The magnetic base 23 is a circular outer cover having a central hole 231. Thick and thin magnet sets 22 and 21 are sequentially disposed in the magnetic base 23 and adhered together by an adhesive so that the thick and thin magnet sets 22 and 21 and the magnetic base 23 form the precise concentricity. Also, the thick and thin magnet sets 22 and 21 is separated from the circumferential wall of the magnetic base 23 by a proper gap.

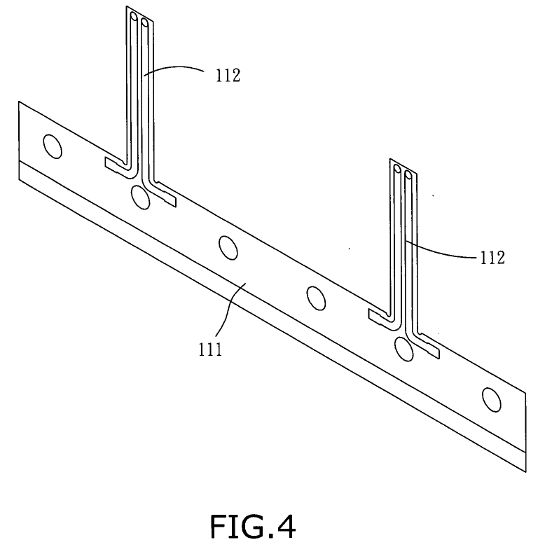

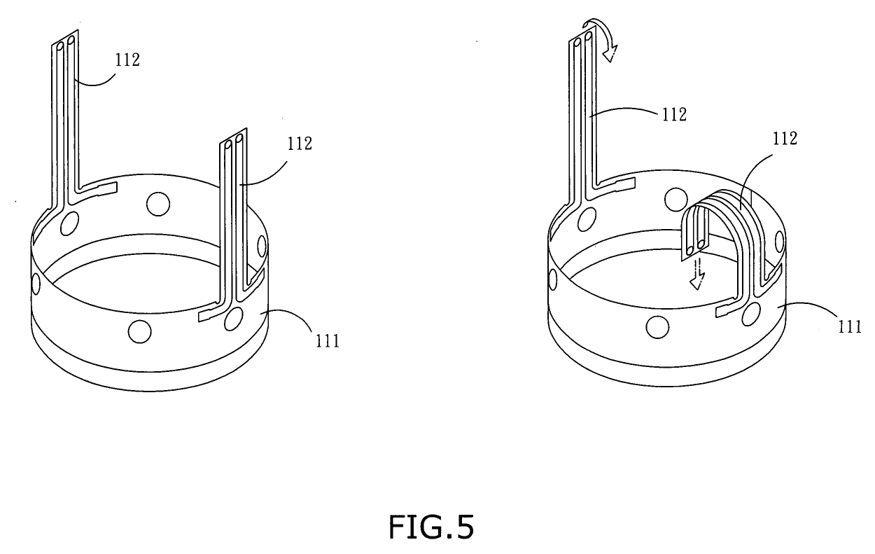

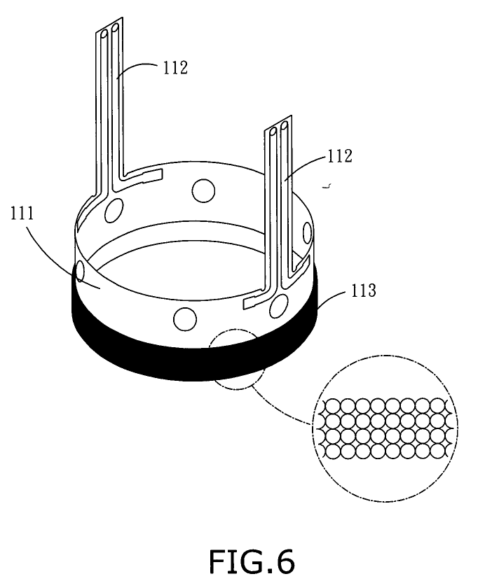

FIGS. 4 to 6 are respectively a schematically developed view showing a voice coil frame, a schematic illustration showing operations of forming the voice coil frame and an external and partially cross-sectional view showing a voice coil according to the preferred embodiment of the invention. As shown in FIG. 4, the voice coil frame 111 has the TT pattern before it is shaped and is formed by a flexible plastic film covering a central wire so that the voice coil frame 111 cannot be easily damaged. Opposite projecting lead-out portions 112 are formed at proper positions of one lateral circumference to facilitate the bonding to the conductive terminals 114. As shown in FIG. 5, the voice coil frame 111 is shaped by winding the flexible plastic film with the TT pattern to form a cylindrical shape, and the two lead-out portions 112 are curved toward the inside of the circle. Free ends of the lead-out portions 112 are bonded to the conductive terminals 114 and adhered to the inner wall of the guide-out tube 115 so that the terminals 114 are exposed out of the edge of the guide-out tube 115 to facilitate the coupling to the power. As shown in FIG. 6, another lateral circumference of the voice coil frame 111 away from the lead-out portions 112 is wounded with the multi-layer copper wire 113. In this example, four layers of the copper wire 113 are wound in an overlapped manner.

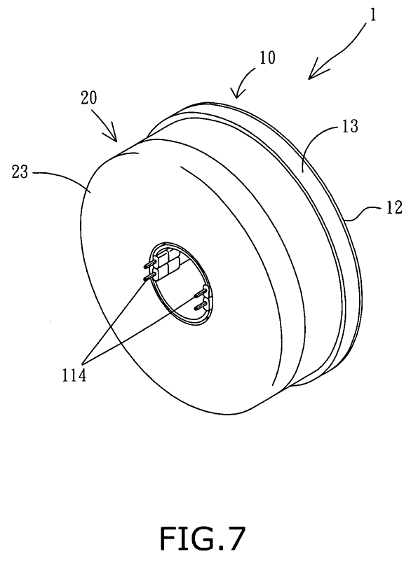

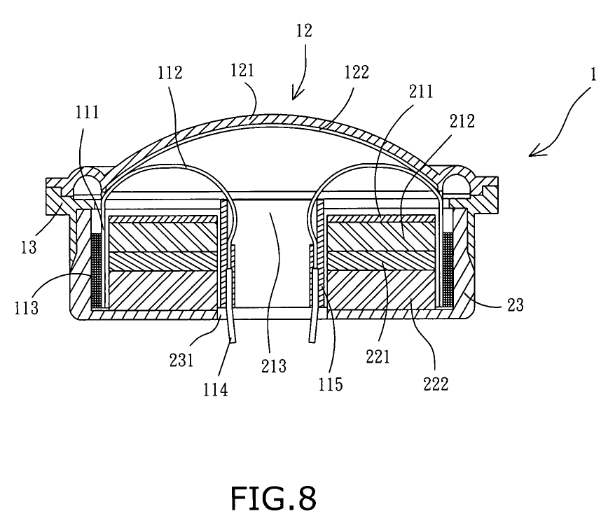

FIGS. 7 and 8 are respectively an externally assembled view and an overall cross-sectional view showing the speaker according to the preferred embodiment of the invention. According to the speaker 1 composed of the above-mentioned components, the pretty and bijou exterior can be obtained, and the concept of the light, thin and miniaturized design can be achieved. Meanwhile, the power carrying capacity can be enhanced and the distortion can be reduced because the special functional members including the double-layer material diaphragm formed of a metal film and a plastic film, the voice coil frame composed of the TT plastic film, four layers of overlapped copper wire, and the magnetic loop assembly composed of the thin and thick magnet sets are employed.

As mentioned hereinabove, the special material is selected to form the speaker with a special design in this invention. So, the power output can be effectively enhanced under the precondition of the light, thin and miniaturized exterior, and the excellent behavior in the aspects of the loudness of the voice and the extension and distortion of the frequency band can be obtained. Thus, the speaker of the invention has the advanced utility.

In summary, the structure of the miniaturized high power speaker of the invention has overcome the drawbacks of the prior art, and the overall functions and effects of the product are significantly enhanced so that the speaker has the high utility in the industry.

New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

What is claimed is:

1. A structure of a miniaturized high power speaker being composed of a vibrator and a magnetic loop assembly, wherein:
the vibrator comprises:
a voice coil set having a cylindrical voice coil frame, one lateral circumference formed with projecting and opposite lead-out portions, and another lateral circumference wound with a copper wire, wherein each of the lead-out portions is bonded to a conductive terminal and adhered to an inner wall of a guide-out tube with the terminal being exposed out of an edge of the guide-out tube;
a diaphragm, which is composed of an elastic film and a light metal, and is adhered to the voice coil set; and
a flange which is a circular hollow frame body made of a metal material, wherein the voice coil set may be embedded into the circular hollow frame body and adhered to the diaphragm; and
the magnetic loop assembly comprises:
a thin magnet set composed of a thin magnet and a thin washer having a central hole, wherein the thin magnet and the thin washer are pressed and adhered together and are magnetized to have a strong magnetic force;
a thick magnet set composed of a thick magnet and a thick washer having a central hole, wherein the thick magnet and the thick washer are pressed and adhered together, and are magnetized to have another strong magnetic force; and
a magnetic base, which is a circular outer cover having a central hole, wherein the thick magnet set and the thin magnet set are sequentially disposed in the central hole of the circular outer cover concentrically.

2. The structure according to claim 1, wherein the voice coil frame is a flexible plastic film having a TT pattern before it is shaped.

3. The structure according to claim 1, wherein the copper wire wound around the voice coil frame has a multi-layered and overlapped pattern.

4. The structure according to claim 1, wherein the thick and thin magnet sets are embedded in the magnetic base and are separated from a circumferential wall of the magnetic base by a gap.
